(19) United States
(12) Patent Application Publication
(10) Pub. No.: US 2025/0339345 A1
(43) Pub. Date: Nov. 6, 2025

(54) Collection Assembly

(71) Applicant: HR Pharmaceuticals, Inc., York, PA (US)

(72) Inventors: Matt Hanna, Lancaster, PA (US); Colby Wiesman, Wrightsville, PA (US)

(73) Assignee: HR Pharmaceuticals, Inc., York, PA (US)

(21) Appl. No.: 18/653,614

(22) Filed: May 2, 2024

(51) Int. Cl. A61J 1/22; A61J 1/20

(52) U.S. Cl. CPC A61J 1/22; A61J 1/2062

(57) ABSTRACT

A collection assembly includes a vessel. The collection assembly includes a movement control device coupled to a connector receiving channel. The collection assembly further includes a connector device coupled the vessel.

### FIELD OF THE INVENTION

The present invention pertains to a collection assembly and, more particularly, to an improved collection assembly for receiving and sampling urine.

### BACKGROUND

In healthcare settings across the continuum of care, healthcare practitioners commonly utilize indwelling catheters and standard intermittent catheter trays to void non-ambulatory patients. These methods of draining the bladder of a non-ambulatory patient pose several challenges in care delivery, including, without limitation, increased risk of catheter acquired urinary tract infections (CAUTIs), urinary tract infections (UTIs), exposure to patient urine and bodily fluids, and the need to gather supplies to properly perform a sterile catheterization procedure. Despite several advances throughout the years, the current methodologies utilized drain urine from non-ambulatory patients remain lackluster and are rife with inefficiencies. As such, there remains a need in the market for a product that leverages the technology and clinical benefits of an intermittent closed system catheter with an introducer tip to efficiently and seamlessly void urine from non-ambulatory patients and efficiently capture sterile urine samples for analysis.

### SUMMARY

A collection assembly includes a vessel providing a first external layer and a second external layer sealed around a first periphery and a second periphery. The first periphery is permitted for holding a fluid, the second periphery is permitted to release the fluid, a movement control device coupled to a connector receiving channel of the first periphery, a connector device coupled the vessel.

### BRIEF DESCRIPTION OF DRAWINGS

In the following, the present invention is described in more detail with references to the drawings in which:

FIG. 1 is a front, top and left side perspective view of a bag collection assembly according to the invention;

FIG. 2 is a front perspective view of the invention of FIG. 1;

FIG. 3 is a left side perspective view of the invention of FIG. 2;

FIG. 4 is a cross-sectional view of FIG. 3;

FIG. 5 is a front, top and left side perspective view thereof of FIG. 4;

FIG. 6 is a front, top and right side perspective view;

FIG. 7 is a front perspective view of FIG. 6;

FIG. 8 is a front, top, right side perspective view;

FIG. 9 is a front perspective view of FIG. 8;

FIG. 10 is a rear perspective view;

FIG. 11 is a right side perspective view;

FIG. 12 is a top perspective view;

FIG. 13 is a bottom perspective view;

FIG. 14 is a rear, bottom and right side perspective view of a bag collection assembly according to the invention;

FIG. 15 is a front, top, right side perspective view;

FIG. 16 is a right side perspective view;

FIG. 17 is a left side perspective view;

FIG. 18 is a top perspective view;

FIG. 19 is a bottom perspective view;

FIG. 20 is a perspective view of an intermittent tray; and

FIG. 21 is a perspective view of the collection assembly provided within the intermittent tray.

### DETAILED DESCRIPTION OF THE EMBODIMENTS

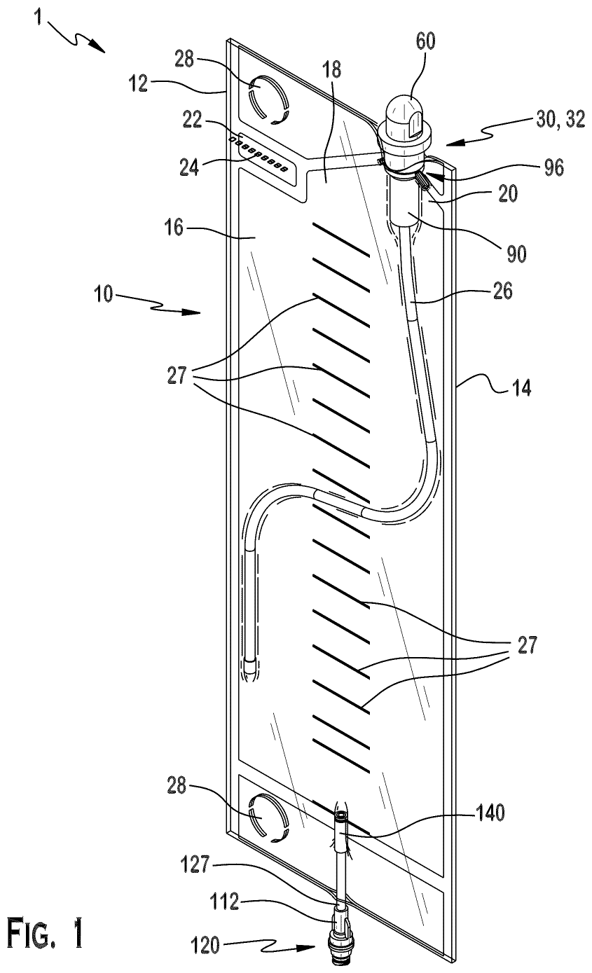

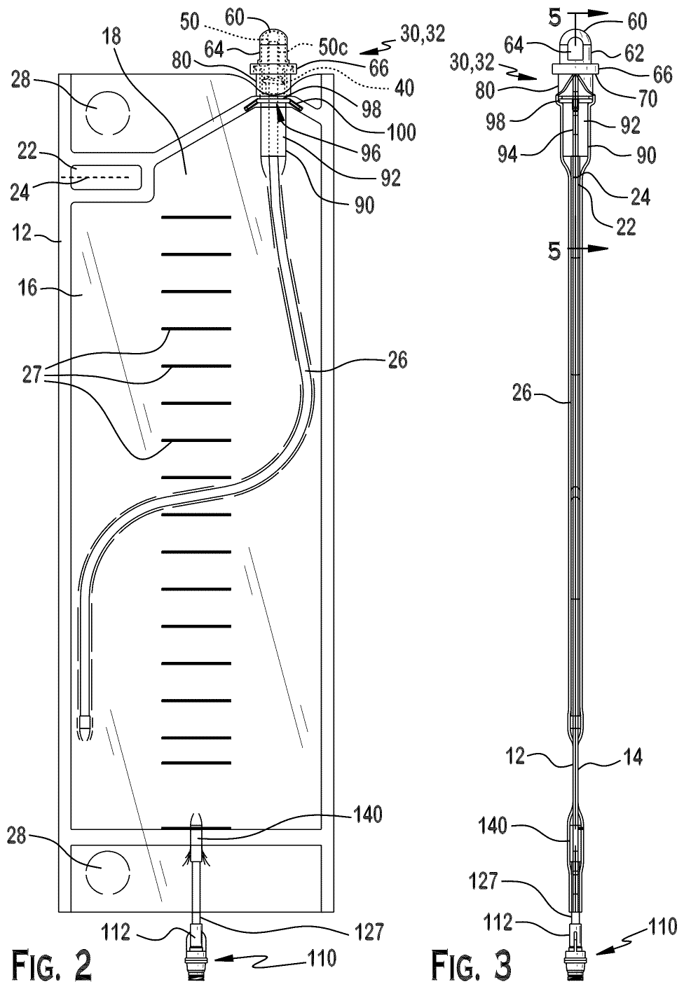

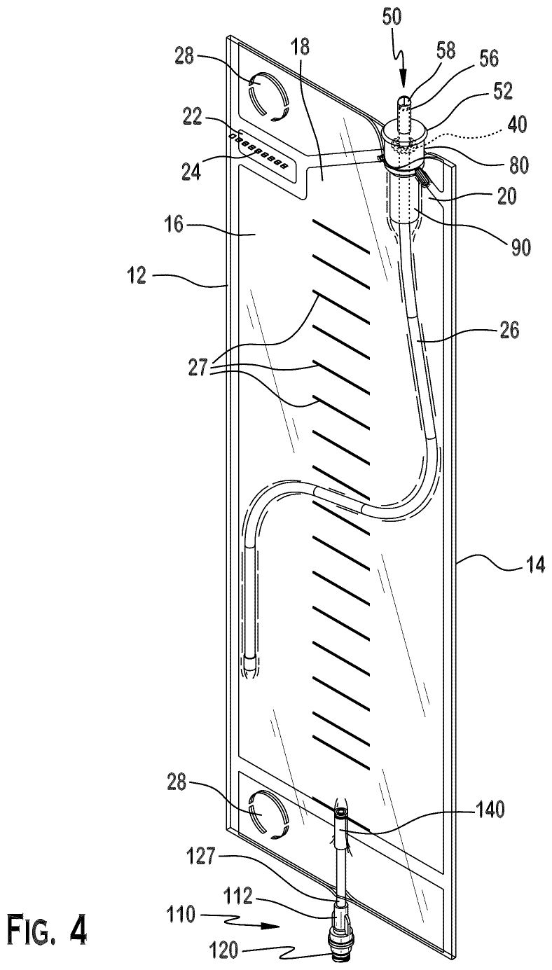

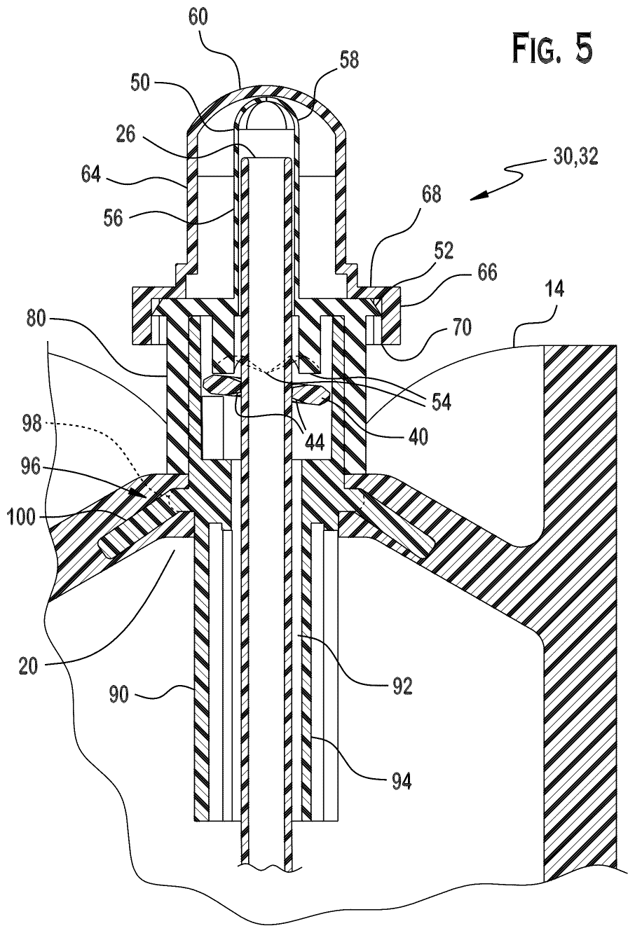

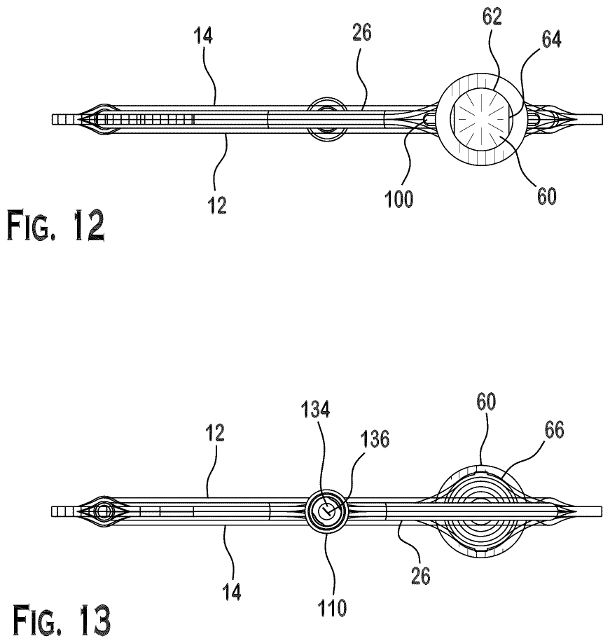

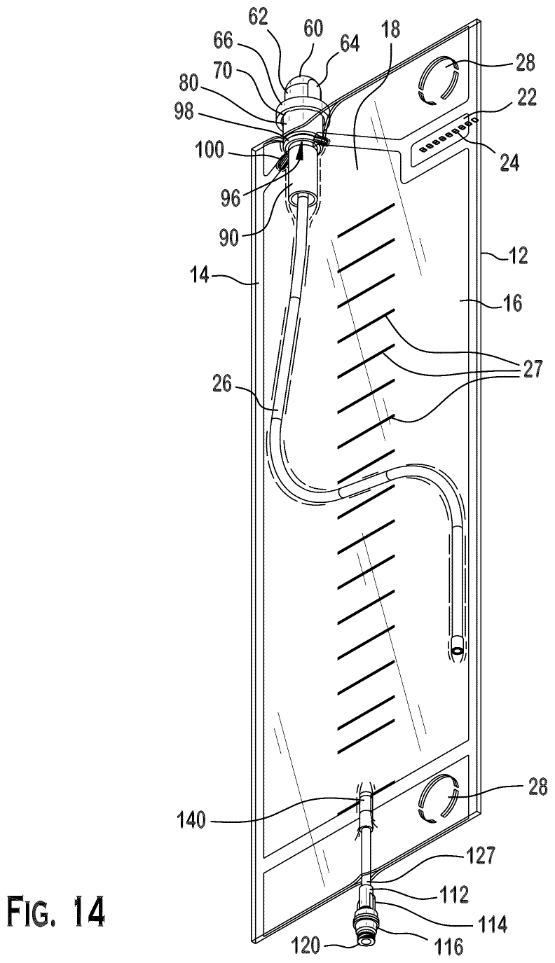

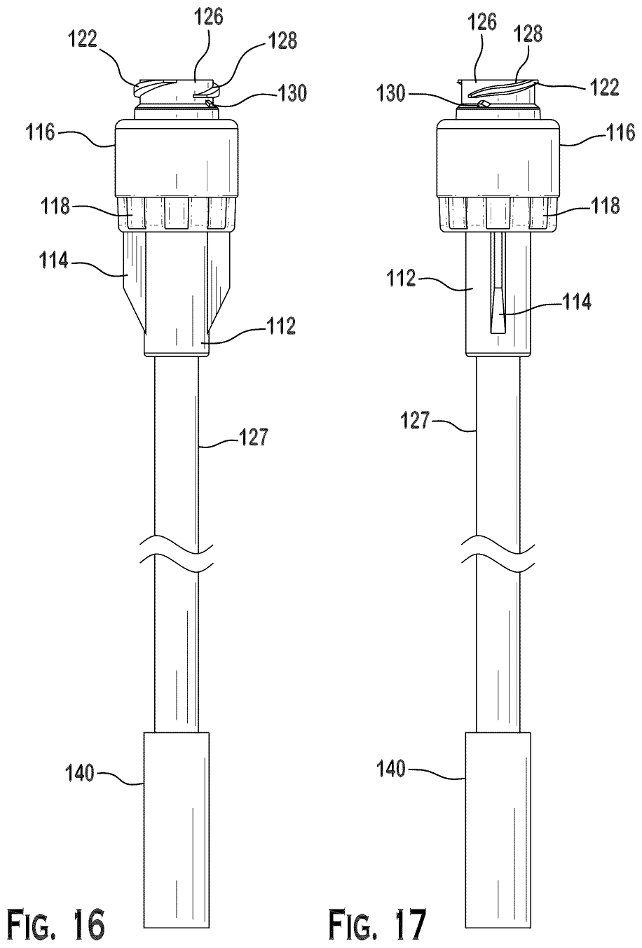

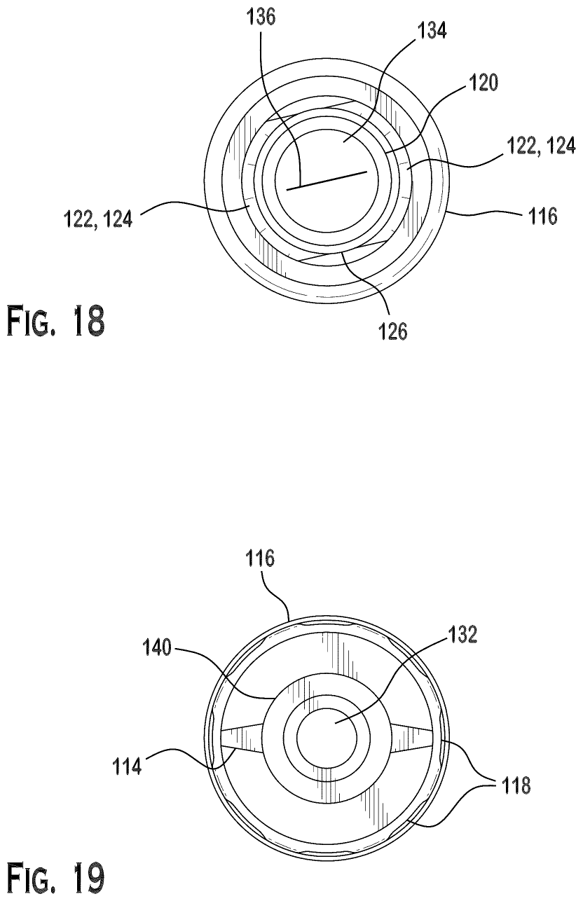

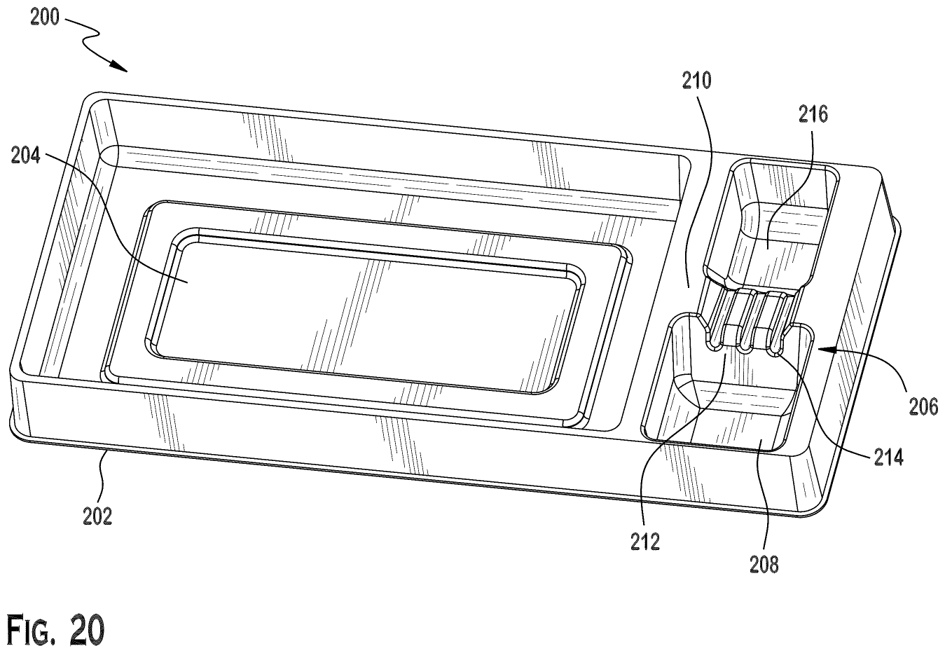

With reference to FIGS. 1-21, a collection assembly 1 according to the invention is shown. In an exemplary embodiment shown, a collection assembly 1 according to the invention generally includes a vessel 10, a movement control device 30 and a connector device 110.

In the exemplary embodiment, the vessel 10 includes a first external layer 12 and a second external layer 14 sealed around a first periphery to define an inner profile. The inner profile further includes a container portion 16 for holding fluid. The inner profile further includes an elongated portion 18. The elongated portion 18 includes a connector receiving channel 20 positioned near the elongated portion 18. A length of the vessel 10 is 425 mm. One skilled in the art would understand the applicant's design is not the exclusive embodiment.

In the exemplary embodiment, the inner profile further includes the first external layer 12 and the second external layer 14 sealed around a second periphery to define a rectangular exit way 22 for draining fluid from the container portion 16. The exit way 22 further includes a tear seam 24. The tear seam 24 is a plurality of perforated lines. In some embodiments, the first external layer 12 and the second external layer 14 may be sealed together by welding. In other embodiments, the first external layer 12 and the second external layer 14 may be sealed by other fastening techniques. One skilled in the art would understand the applicant's design is not the exclusive embodiment.

In the exemplary embodiment, the vessel 10 further includes tubing 26. One skilled in the art would understand the tubing 26 is medical tubing or similar forms thereof. The tubing 26 is positioned within the inner profile of the container portion 16 of the vessel 10.

In the exemplary embodiment, the vessel 10 further includes a plurality of scale marks 27 for indicating the amount of fluid within the container portion 16. The plurality of scale marks are positioned on a central portion of both the first external layer 12 and the second external layer 14. The plurality of scale marks 27 may indicate cubic centimeters (“CC”). One skilled in the art would understand the applicant's design is not the exclusive embodiment.

In the exemplary embodiment, the vessel 10 further includes a pair of passageways 28 for coupling to various equipment. Each passageway is a circular opening extending through both the first external layer 12 and the second external layer 14. One skilled in the art would understand the applicant's design of the passageway 28 being circular is not the exclusive embodiment. In other embodiments, the passageway 28 may be another polygonal shape. Each passageway 28 is positioned adjacent and outside the container portion 16. Further, each passageway 28 is positioned on opposing ends of the vessel 10.

In the exemplary embodiment and as shown in FIGS. 1-14, a movement control device 30 generally includes a housing 32. The housing 32 includes a retainer 40, a dispenser 50 and a cap 60.

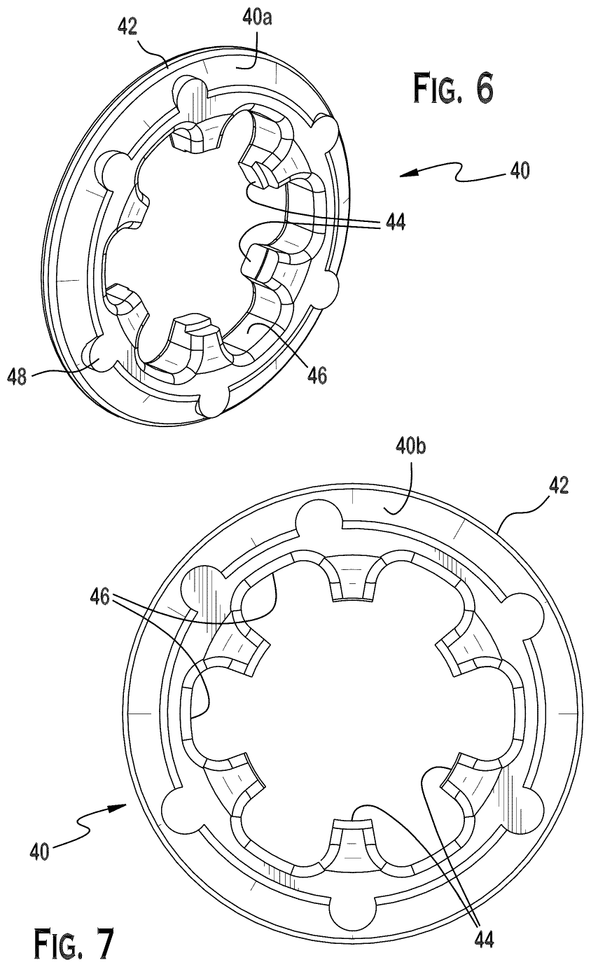

In the exemplary embodiment, as shown in FIGS. 6-7, the retainer 40 is generally composed of a ring member 42. One of ordinary skill in the art would understand the applicant's design is not the exclusive embodiment. In the exemplary embodiment, the retainer 40 further includes a first face 40a and a second face 40b on the ring member 42. One of ordinary skill in the art would understand the applicant's design is not the exclusive embodiment.

In the exemplary embodiment, the retainer 40 further includes a retainer opening located in the center of the ring member 42. One of ordinary skill in the art would understand the applicant's design is not the exclusive embodiment.

In the exemplary embodiment, the retainer 40 further includes a plurality of teeth-like protrusions 44 extending inwards towards the retainer opening. One of ordinary skill in the art would understand the applicant's design is not the exclusive embodiment.

In the exemplary embodiment, the retainer 40 further includes a plurality of retainer indentations 46 located between each teeth-like protrusion 44 extending away from the retainer opening. One of ordinary skill in the art would understand the applicant's design is not the exclusive embodiment.

In the exemplary embodiment, the retainer 40 further includes a plurality of circular protrusions 48 located on both the first face 40a and the second face 40b of the ring member 42. One of ordinary skill in the art would understand the applicant's design is not the exclusive embodiment.

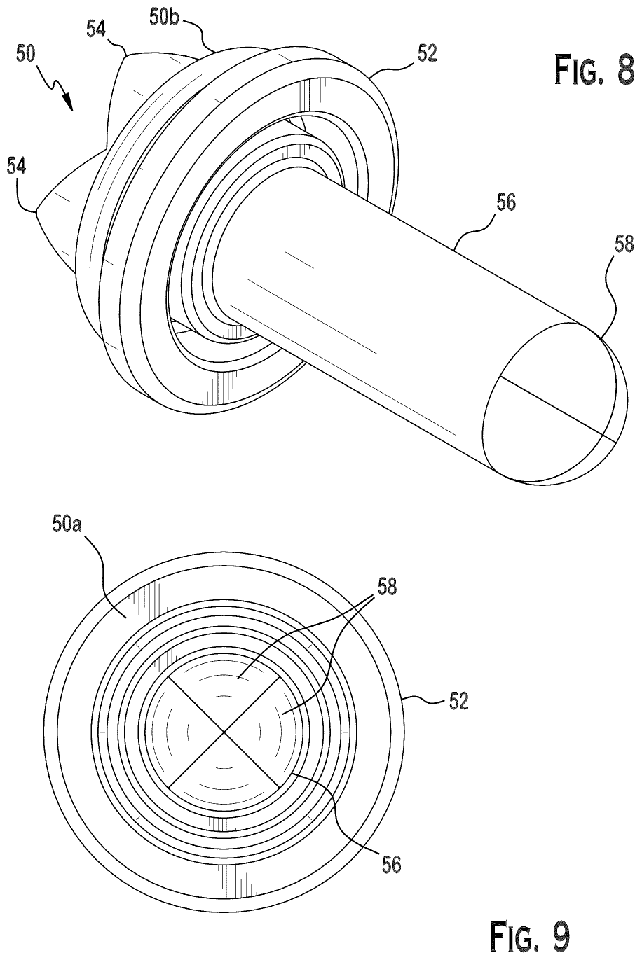

In the exemplary embodiment, as shown in FIGS. 8-9, the dispenser 50 is mainly composed of a tip base 52, a biasing surface 54 and a protruding end piece 56. One of ordinary skill in the art would understand the applicant's design is not the exclusive embodiment.

The dispenser 50 further includes a front face 50a and a rear face 50b. The dispenser 50 also includes a dispenser passageway 50c running the length of the dispenser 50. One of ordinary skill in the art would understand the applicant's design is not the exclusive embodiment.

In the exemplary embodiment, the tip base 52 is a shortened cylindrical member. One of ordinary skill in the art would understand the applicant's design is not the exclusive embodiment.

In the exemplary embodiment, the biasing surface 54 is a protruding wall positioned on the rear face 50b extending outward. One of ordinary skill in the art would understand the applicant's design is not the exclusive embodiment.

In the exemplary embodiment, the protruding end piece 56 is positioned on the front face 50a extending outwards from the tip base 52. One of ordinary skill in the art would understand the applicant's design is not the exclusive embodiment. In the exemplary embodiment, the protruding end piece 56 further includes a distal tip 58. One of ordinary skill in the art would understand the applicant's design is not the exclusive embodiment.

In the exemplary embodiment, the distal tip 58 further includes an “X shaped” opening. One of ordinary skill in the art would understand the applicant's design is not the exclusive embodiment.

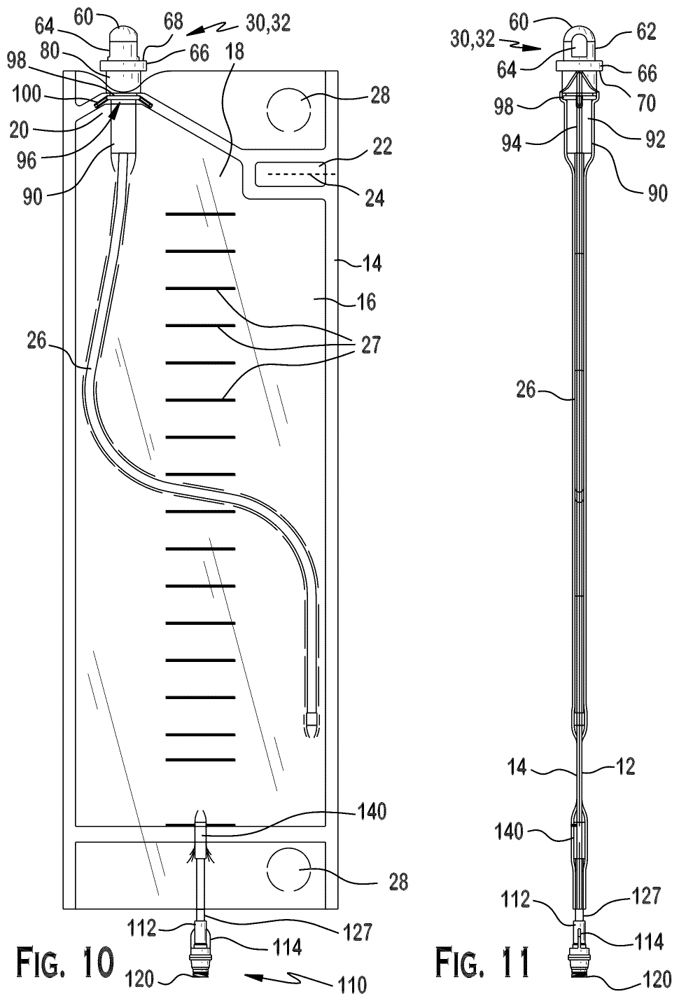

In the exemplary embodiment, as shown in FIGS. 10-11, the front cap 60 further includes a protruding end piece receiver 62 and a locking mechanism 66. The receiver 62 is a cylindrical member and includes an outer surface and an inner surface. The outer surface includes a pair of vertically positioned grips 64 extending along opposing sides of the outer surface. One of ordinary skill in the art would understand the applicant's design is not the exclusive embodiment.

The locking mechanism 66 is circular and extends around the perimeter of the base 68 while extending below the base 68 of the receiver 62, creating a ledge 70 for coupling to the tip base 52. One of ordinary skill in the art would understand the applicant's design is not the exclusive embodiment.

In the exemplary embodiment, the dispenser 50 further includes a protective shell 80. The protective shell 80 is a cylindrically hollow structure allowing the tip base 52 to couple within the protective shell 80. Specifically, the biasing surface 54 is positioned within the protective shell 80 and provides a housing for the retainer 40. One skilled in the art would understand the applicant's design is not the exclusive embodiment. The protective shell 80 is positioned outside the first external layer 12 and the second external layer 14. In another embodiment, the protective shell 80 is positioned within the first external layer 12 and the second external layer 14. One skilled in the art would understand the applicant's design is not the exclusive embodiment.

In the exemplary embodiment, the dispenser 50 further includes a receiver 90. The receiver 90 is an elongated cylindrical member positioned within the connector receiving channel 20. The receiver 90 further includes a passageway 92 extending a length of the receiver 90. The receiver further includes within the passageway 92, a guiding channel 94. The guiding channel 94 is a c-shaped wall positioned in a central portion and extending along the length of the receiver 90. The guiding channel 94 permits entry of the tubing 26, allowing stability to the tubing 26 while threading the tubing 26 through the distal tip 58. The receiver 90 further includes a stabilizer 96. The stabilizer 96 includes a ring 98 and a pair of flanges 100 extending away and outwards from the ring 98. The ring 98 is positioned around the receiver 90 in order to provide restricted movement to the receiver 90. Additionally, the pair of flanges 100 aid the ring 98 in providing restricted movement to the receiver 90.

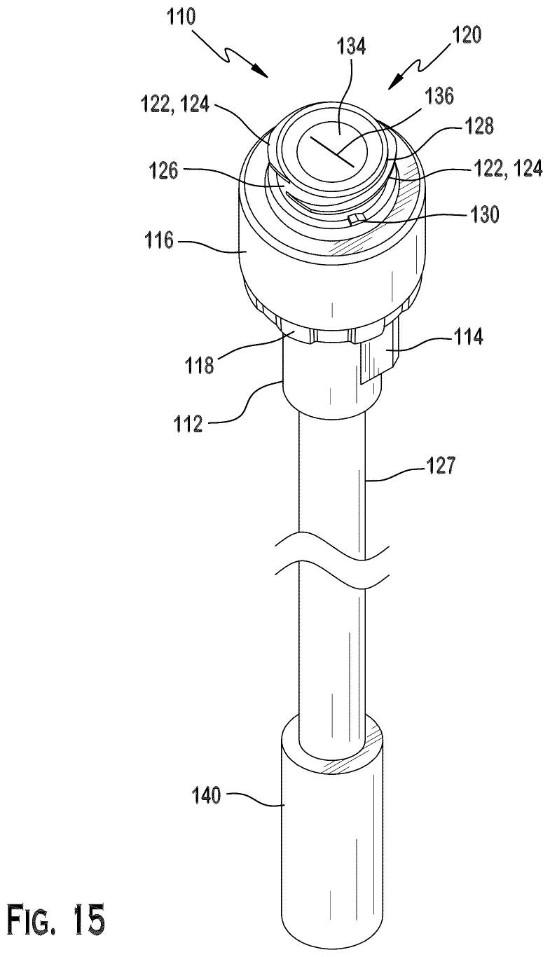

In the exemplary embodiment and as shown in FIGS. 15-19, a connector device 110 includes a body assembly 112. The body assembly 112 is an elongated cylindrical member. The body assembly 112 further includes a pair of fins 114 extending outwards along a portion of the body assembly 112. Each fin 114 is trapezoidal shaped. The body assembly 112 further includes a passageway extending through, for receiving a connector tubing 127. In an exemplary embodiment of the invention, a width of the opening of the passageway is 5.8 mm. An inside of the passageway is 4 mm+/−0.1. One skilled in the art would understand the applicant's design is not the exclusive embodiment.

In the exemplary embodiment, the body assembly 112 further includes a collar 116 positioned abutting a top of the body assembly 112. A width of the collar 116 is 11.3 mm. The collar 116 cylindrically extends about the body assembly 112. The collar 116 further includes a plurality of ridges 118 extending around a perimeter of a lower portion of the collar 116.

In the exemplary embodiment and as shown in FIGS. 15-19, the connector device 110 further includes a head assembly 120. The head assembly 120 is a cylindrical member having a circumference less than a circumference of the collar 116. In an exemplary embodiment of the invention, a width of the head assembly 120 is 7.8 mm. One skilled in the art would understand the applicant's design is not the exclusive embodiment. The head assembly 120 includes an attachment member 122. The attachment member 122 is a plurality of rails 124. Each of the rails 124 form a spiral pattern along an outer surface of the head assembly 120 and towards the collar 116. Each of the rails 124 further extend over a side wall 126 forming a ledge 128. One skilled in the art would understand the applicant's design is not the exclusive embodiment.

In the exemplary embodiment, the attachment member 122 further includes a lock mechanism 130. The lock mechanism 130 is a polygonal member positioned at the base of the head assembly 120. The lock mechanism 130 extends lower than the plurality of rails 124 as shown in FIG. 15.

In the exemplary embodiment, the head assembly 120 further includes a passageway 132 extending through the head assembly 120 and coupling to the passageway of the body assembly 112. The head assembly 120 further includes a cover 134 positioned over the passageway 132. The cover 134 further includes a slit 136 allowing for entry through the cover 134 to the passageway 132.

In the exemplary embodiment, and as shown in FIGS. 15-19, an end connector 140 is provided. The end connector 140 is a cylindrical member which couples to the connector tubing 127 and the body assembly 112 and head assembly 120.

In the exemplary embodiment, the body assembly 112 and the head assembly 120 are composed of polycarbonate (“PC”) and silicone. One skilled in the art would understand the applicant's design is not the exclusive embodiment. A far end of the body assembly 112 and an opposing far end of the head assembly 120 includes a length of 25.3 mm+/−0.5.

In the exemplary embodiment, the connector tubing 127 includes a width of 0.157 mm. The connector tubing 127 is composed of polyvinyl chloride (“PVC”). One skilled in the art would understand the applicant's design is not the exclusive embodiment.

In the exemplary embodiment, a far end of the head assembly 120 to an opposing far end of the end connector 140 is 78 mm. One skilled in the art would understand the applicant's design is not the exclusive embodiment. A length of the end connector 140 is 18 mm. One skilled in the art would understand the applicant's design is not the exclusive embodiment. A width of the end connector 140 is 0.236 mm. The end connector 140 further includes an outer layer of low density polyethylene (“LDPE”). The end connector 140 further includes a binding layer positioned against the outer layer and an inner layer. The inner layer is composed of thermoplastic polyurethane (“TPU”). The outer layer, binding layer and inner layer form a three layer co-extrusion end connector 140. One skilled in the art would understand the applicant's design is not the exclusive embodiment.

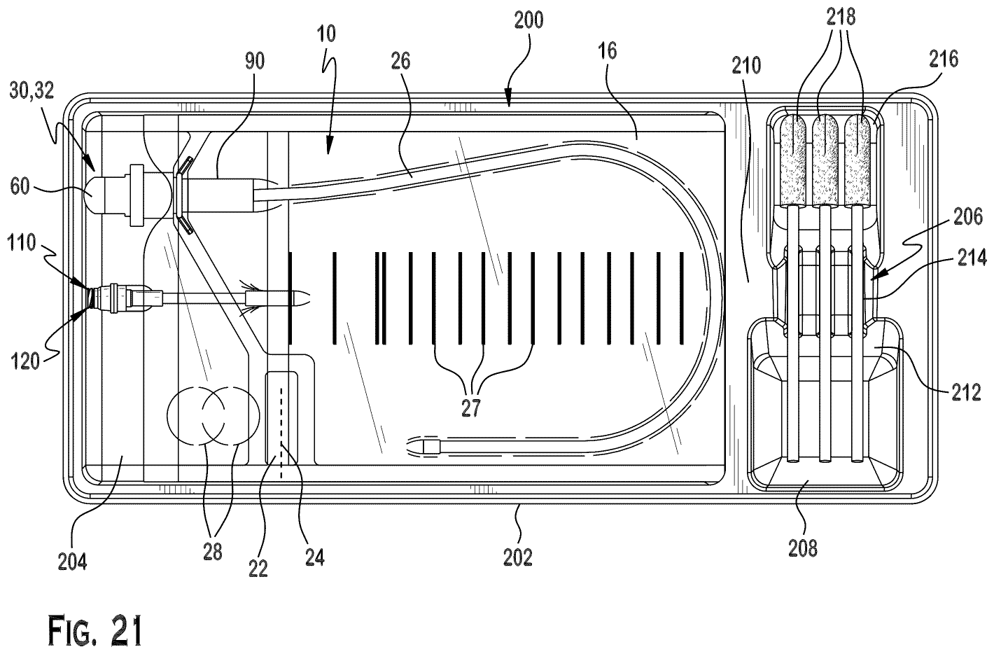

In the exemplary embodiment and as shown in FIGS. 20-21, the collection assembly 1 will be positioned within an intermittent tray 200. The intermittent tray 200 includes a rectangular base 202. The intermittent tray 200 further includes a first slot 204 and a second slot 206.

In the exemplary embodiment, the first slot 204 is rectangular shaped and extends almost the entire length of the base 202. The first slot 204 is permitted to receive the collection assembly 1, specifically the collection assembly 1 is nestled within the first slot 204. The second slot 206 is positioned adjacent the first slot 204 and extends a width of the base 202. The second slot 206 further includes an upper portion 208. The upper portion 208 is a rectangular indentation within the intermittent tray 200. The second slot 206 further includes a central portion 210. The central portion 210 includes a pair of protruding walls 212. The pair of protruding walls 212 are elongated members, specifically, each of the protruding walls 212 is cylindrical which extends in a parallel direction to the width of the rectangular base 202. One skilled in the art would understand the applicant's design is not the exclusive embodiment. The pair of protruding walls 212 define a plurality of slots 214 as shown. One skilled in the art would understand the applicant's design is not the exclusive embodiment. The second slot 206 further includes a lower portion 216. The lower portion 216 is a rectangular indentation within the intermittent tray 200, specifically, the lower portion 216 includes a smaller perimeter than the upper portion 208. The second slot 206 will permit and secure a plurality of medical swabs 218. Specifically, the swabs 218 will be inserted into the plurality of slots 214. One skilled in the art would understand the applicant's design is not the exclusive embodiment.

In the exemplary embodiment, the user will remove the contents and the collection assembly 1 from the intermittent tray 200.

When utilizing the collection assembly 1, a user will remove the front cap 60 allowing the dispenser 50 and specifically the distal tip 58 to be exposed. The user will then guide the tubing 26 first through the guiding receiving channel 94. Once the tubing reaches the end of the guiding receiving channel 94, the tubing 26 enters the protective shell 80 and glides along the protective shell 80 towards the retainer 40. When the tubing 26 reaches the retainer 40, the tubing 26 is threaded through the retainer opening of the retainer 40.

Once the tubing 26 is positioned through the retainer opening, the tubing 26 is then inserted into the dispenser passageway 50c where the retainer 40 is positioned between the rear face 50b of the dispenser 50 and the protective shell 80. One of ordinary skill in the art would understand the applicant's design is not the exclusive embodiment.

In a first state, while the tubing 26 is threaded through the dispenser 50, the retainer 40 is angled and is not in contact with the biasing surface 54, which allows for the tubing 26 to freely move in a first direction. The tubing 26 travels through the dispenser passageway 50c and penetrates the distal tip 58 of the dispenser 50. The fluid from the penis is then received through the tubing 26 and allows for the fluid from the penis to flow to the container portion 16.

In a second state, if the tubing 26 is moving away from the dispenser 50, the retainer 40 is angled perpendicular to the movement control device 30. Specifically, the first face 40a of the retainer 40 is in contact and flush against the biasing surface 54 to offer friction and slow or prevent movement of the tubing 26 unless a greater force is exerted on the tubing 26 to overcome the friction.

In the exemplary embodiment, the connector device 110 permits a user to retrieve a sample or a plurality of samples from the container portion 16. Allowing both an egress and an ingress of fluid within the container portion 16.

The foregoing illustrates some of the possibilities for practicing the invention. Many other embodiments and fields of use for collection assembly according to the invention are possible and within the scope and spirit of the invention. It is therefore intended that the foregoing description be regarded as illustrative rather than limiting.

It will be understood that changes in the details, materials, steps and arrangements of parts which have been described and illustrated to explain the nature of the invention will occur to and may be made by those skilled in the art upon a reading of this disclosure within the principles and scope of the invention; however, concepts, as based upon the description, may be employed in other embodiments without departing from the scope of the invention.

What is claimed is:

1. A collection assembly comprising:
a vessel providing a first external layer and a second external layer sealed around a first periphery and a second periphery; the first periphery is permitted for holding a fluid, the second periphery is permitted to release the fluid;
a movement control device coupled to a connector receiving channel of the first periphery; and
a connector device coupled the vessel.

2. The collection assembly of claim 1, wherein the connector device is coupled to the first periphery.

3. The collection assembly of claim 2, wherein the vessel further includes an elongated portion in the first periphery.

4. The collection assembly of claim 3, wherein the second periphery includes a tear seam.

5. The collection assembly of claim 4, wherein the vessel further includes a plurality of scale marks for indicating the amount of fluid within the first periphery.

6. The collection assembly of claim 5, wherein the vessel further includes a pair of passageways positioned on opposing ends of the first periphery.

7. The collection assembly of claim 6, wherein the movement control device includes a retainer, a dispenser and a cap.

8. The collection assembly of claim 7, wherein the retainer is a ring member.

9. The collection assembly of claim 8, wherein the retainer is positioned within a housing.

10. The collection assembly of claim 9, wherein the connector device includes a pair of fins extending outwards from a body assembly of the connector device.

11. The collection assembly of claim 10, wherein the connector device includes an end connector coupling to a connector tubing and coupling to the body assembly.

12. A collection assembly comprising:
a container portion with a plurality of scale marks;
an exit way positioned adjacent and outside the container portion;
a movement control device coupled to a first end of the collection assembly;
a connector device coupled to a second end of the collection assembly; a tubing positioned within the container portion, coupling the movement control device to container portion and permitting fluid to enter the container portion.

13. The collection assembly of claim 12, wherein the movement control device is sealed to a first external layer and a second external layer.

14. The collection assembly of claim 13, wherein the connector device is sealed to the first external layer and the second external layer.

15. The collection assembly of claim 14, wherein the movement control device further includes a distal tip.

16. The collection assembly of claim 15, wherein the movement control device further includes a protective shell coupling to the distal tip positioned outside the container portion.

17. The collection assembly of claim 16, wherein the movement control device further includes a receiver positioned within the container portion and coupled to the protective shell.

18. The collection assembly of claim 17, wherein the tubing extends through the receiver, the protective shell and the distal tip.

19. An intermittent tray having:
a first slot, the first slot extends almost an entire length of the intermittent tray;
a second slot, the second slot is positioned adjacent the first slot;
a collection assembly nestled within the first slot, the collection assembly having:
a container portion permitted to retain fluid;
a movement control device coupled to an upper end of the container portion; and
a connector device coupled to an opposite end of the container portion with respect to the movement control device.
